(19) United States
(12) Patent Application Publication
(10) Pub. No.: US 2025/0159605 A1
(43) Pub. Date: May 15, 2025

(54) RESTRICTED TARGET WAKE TIME IN WIRELESS NETWORKS

(71) Applicant: Samsung Electronics Co., Ltd., Suwon-si (KR)

(72) Inventors: Rubayet Shafin, Allen, TX (US); Boon Loong Ng, Plano, TX (US)

(21) Appl. No.: 18/927,758

(22) Filed: Oct. 25, 2024

Related U.S. Application Data
(60) Provisional application No. 63/547,948, filed on Nov. 9, 2023.

(51) Int. Cl. H04W 52/02; H04W 28/02

(52) U.S. Cl. CPC H04W 52/0216; H04W 28/0278

(57) ABSTRACT

A non-access point multi-link device (non-AP MLD) in a wireless network, the non-AP MLD comprising a memory and a processor coupled to the memory, the processor is configured to: establish a membership for a restricted target wake time (R-TWT) schedule with an access point (AP) for a set of traffic identifiers (TIDs); transmit, to the AP, one or more frames corresponding to one or more TIDs that belongs to the set of TIDs within a service period (SP); transmit, to the AP, an indication indicating pending traffic with a TID that does not belong to the first set of TIDs; receive, from the AP, an indication indicating acceptance of transmission of the pending traffic; and transmit, to the AP, one or more frames corresponding to the TID that does not belong to the first set of TIDs.

### CROSS-REFERENCE TO RELATED APPLICATION(S)

This application claims the benefit of priority from U.S. Provisional Application No. 63/547,948, entitled “HANDLING FAIRNESS ISSUE FOR RESTRICTED TWT” filed Nov. 9, 2023, which is incorporated herein by reference in its entirety.

### TECHNICAL FIELD

This disclosure relates generally to a wireless communication system, and more particularly to, for example, but not limited to, restricted target wake time (TWT) operations in wireless networks.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHz, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

One aspect of the present disclosure provides a station (STA) in a wireless network, the STA comprising: a memory; and a processor coupled to the memory. The processor is configured to establish a membership for a restricted target wake time (R-TWT) schedule with an access point (AP) for a set of traffic identifiers (TIDs). The processor is configured to transmit, to the AP, one or more frames corresponding to one or more TIDs that belong to the set of TIDs within a service period (SP). The processor is configured to transmit, to the AP, an indication indicating pending traffic with a TID that does not belong to the set of TIDs. The processor is configured to receive, from the AP, an indication indicating acceptance of transmission of the pending traffic. The processor is configured to transmit, to the AP, one or more frames corresponding to the TID that does not belong to the set of TIDs.

In some embodiments, the indication indicating the pending traffic with the TID that does not belong to the set of TIDs is included within a buffer status report.

In some embodiments, the indication indicating the pending traffic with the TID that does not belong to the set of TIDs is included within a request frame that includes a request to allow transmission of the pending traffic.

In some embodiments, the indication indicating the acceptance is received from the AP within a response frame that allows transmission of the pending traffic.

In some embodiments, the set of TIDs is associated with latency sensitive traffic.

In some embodiments, the TID that does not belong to the set of TIDs is associated with latency tolerant traffic.

In some embodiments, the processor is further configured to receive, from the AP, a trigger frame that solicits transmission of the pending traffic, and the one or more frames corresponding to the TID that does not belong to the set of TIDs is transmitted in response to the trigger frame.

One aspect of the present disclosure provides an access point (AP) in a wireless network, the AP comprising: a memory; and a processor coupled to the memory. The processor is configured to establish a membership for a restricted target wake time (R-TWT) schedule with a station (STA) for a set of traffic identifiers (TIDs). The processor is configured to receive, from the STA, one or more frames corresponding to one or more TIDs that belongs to the set of TIDs within a service period (SP). The processor is configured to receive, from the STA, an indication indicating pending traffic with a TID that does not belong to the set of TIDs. The processor is configured to transmit, to the STA, an indication indicating acceptance of transmission of the pending traffic. The processor is configured to receive, from the STA, one or more frames corresponding to the TID that does not belong to the set of TIDs.

In some embodiments, the indication indicating the pending traffic with the TID that does not belong to the set of TIDs is included within a buffer status report.

In some embodiments, the indication indicating the pending traffic with the TID that does not belong to the set of TIDs is included within a request frame that includes a request to allow transmission of the pending traffic.

In some embodiments, the indication indicating the acceptance is transmitted to the STA within a response frame that allows transmission of the pending traffic.

In some embodiments, the set of TIDs is associated with latency sensitive traffic.

In some embodiments, the TID that does not belong to the set of TIDs is associated with latency tolerant traffic.

In some embodiments, the processor is further configured to transmit, to the STA, a trigger frame that solicits transmission of the pending traffic; and the one or more frames corresponding to the TID that does not belong to the set of TIDs is received in response to the trigger frame.

### BRIEF DESCRIPTION OF THE DRAWINGS

FIG. 1 illustrates an example of a wireless network in accordance with an embodiment.

FIG. 2A illustrates an example of AP in accordance with an embodiment.

FIG. 2B illustrates an example of STA in accordance with an embodiment.

FIG. 3 illustrates an example of multi-link communication operation in accordance with an embodiment.

FIG. 4 illustrates multi-link discovery and setup in accordance with an embodiment.

FIG. 5 illustrates an example of channel under-utilization during restricted TWT SP in accordance with an embodiment.

FIG. 6 illustrates transmitting a buffer status report (BSR) during R-TWT SP in accordance with an embodiment.

FIG. 7 illustrates a response to BSR transmission during R-TWT SP in a non-trigger-based R-TWT SP in accordance with an embodiment.

FIG. 8 illustrates a request rejection in accordance with an embodiment.

FIG. 9 illustrates a request acceptance in accordance with an embodiment.

FIG. 10 illustrates triggering non-R-TWT TID frame transmission in accordance with an embodiment.

FIG. 11 illustrates triggering another STA during the R-TWT SP in accordance with an embodiment.

FIG. 12 illustrates a flow chart of an example process by an STA requesting permission to transmit for a new TID in accordance with an embodiment.

FIG. 13 illustrates a flow chart of an example process by an AP receiving a request from an STA to transmit to a new TID in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

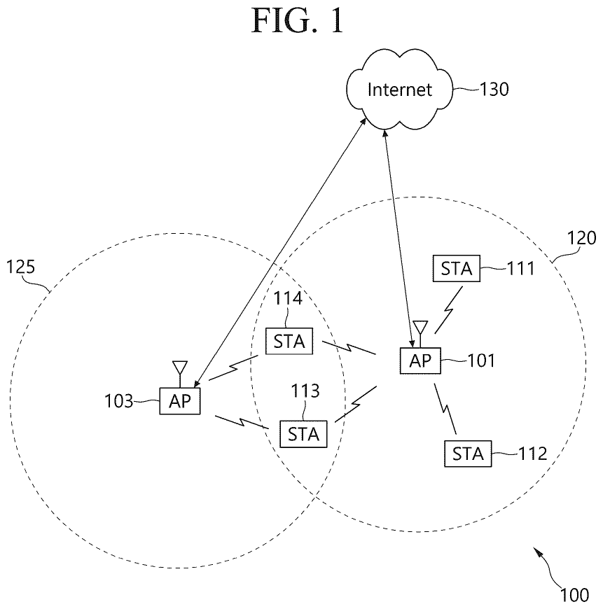

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

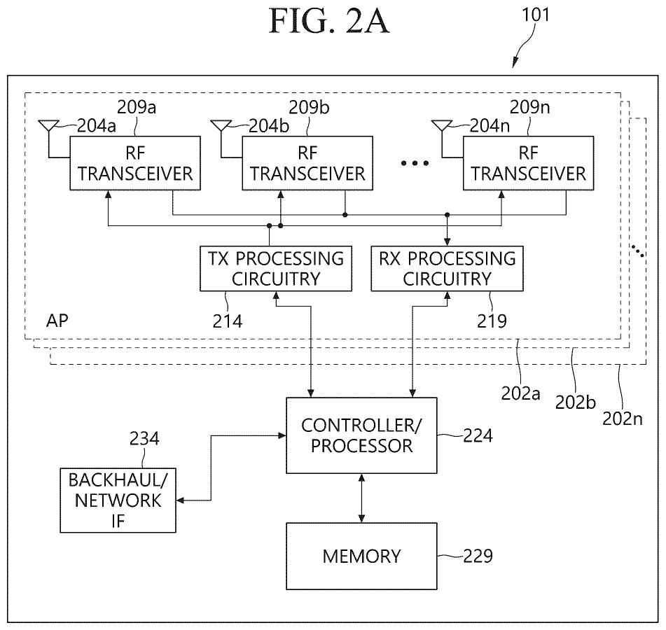

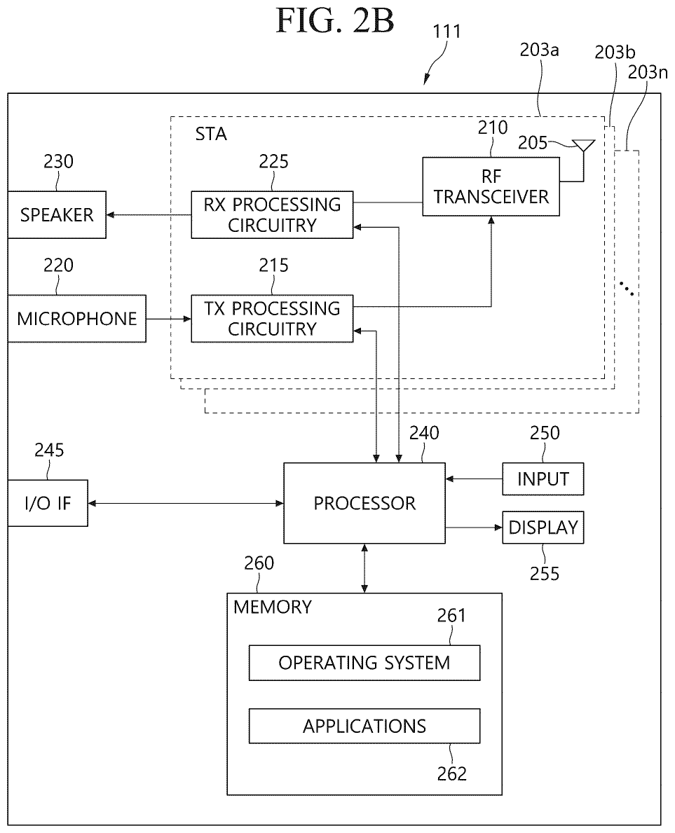

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementation of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

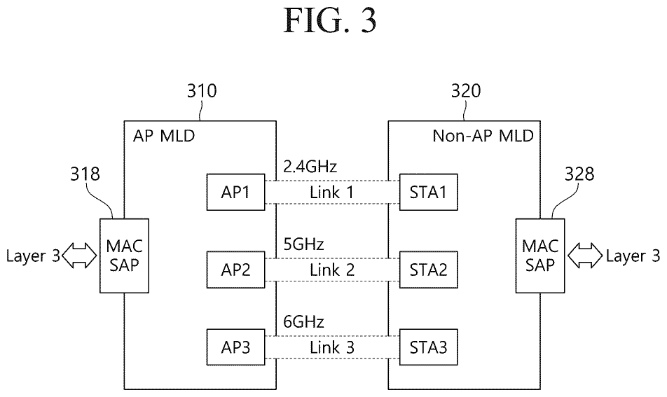

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHz band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021, “Wireless LAN Medium Access Control (MAC) and Physical Layer (PHY) Specifications,” and iii) IEEE P802.11be/D4.0, “Wireless LAN Medium Access Control (MAC) and Physical Layer (PHY) Specifications.”

Multi-link operation may allow the discovery and setup of multiple links between an AP MLD and a non-AP MLD, where the discovery or the setup can take place over a single link.

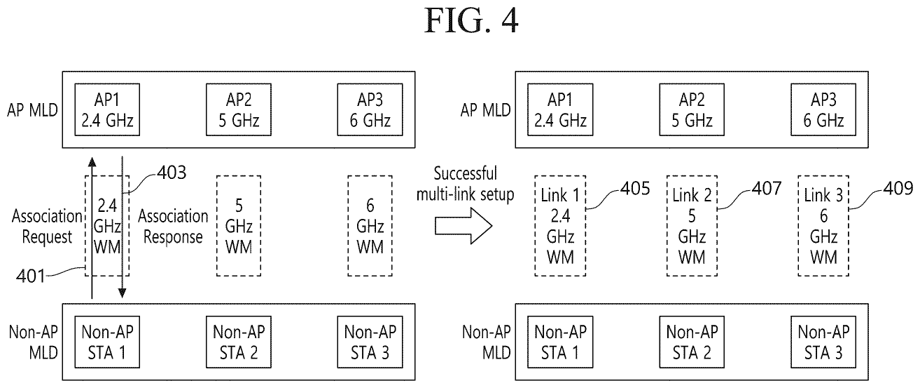

FIG. 4 illustrates multi-link discovery and setup in accordance with an embodiment. In particular, FIG. 4 illustrates an AP MLD communicating with a non-AP MLD. As illustrated, AP MLD is associated with AP1, AP2 and AP3, and non-AP MLD is associated with non-AP STA1, non-AP STA 2, and non-AP STA3. The non-AP MLD transmits an association request frame 401 to AP MLD. AP MLD then transmits an association response frame 403 to non-AP MLD. In FIG. 4, the association request frame 401 and the association response frame takes place over the 2.4 GHz link between the an AP MLD and a non-AP MLD, where the setup is for establishing three links between the AP MLD and the non-AP MLD: one link on the 2.4 GHz band, a second link on the 5 GHz band, and a third link on the 6 GHz band. After the successful setup, the three links, including link 1 at 2.5 GHz 405, link 2 at 5 GHz 407, and link 3 at 6 GHz 409, are established between the AP MLD and the non-AP MLD.

Channel under-utilization may be an issue within restricted TWT (R-TWT) operations. In particular, for R-TWT operation, if an STA has finished transmitting latency-sensitive packets in uplink before the end of a restricted TWT service period (SP) and there is no packet waiting for that STA in downlink for remainder of the SP, then there may be channel under-utilization for that STA if the STA is prohibited from transmitting latency-tolerant traffic for remainder of the SP.

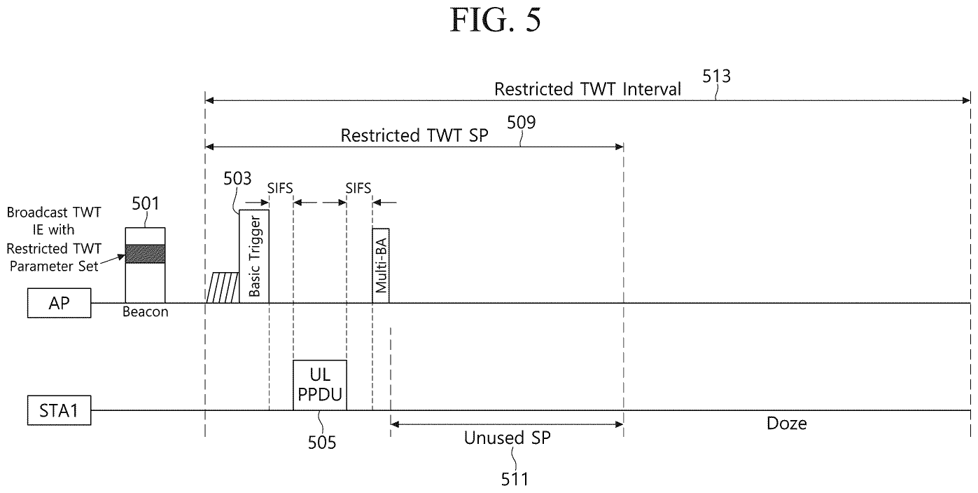

FIG. 5 illustrates an example of channel under-utilization during restricted TWT SP in accordance with an embodiment. In particular, FIG. 5 illustrates an AP and STA communicating on a link. The AP may transmit a beacon frame 501 with a broadcast TWT information element (IE) with restricted TWT parameter set. During the restricted TWT SP 509, the AP may transmit a basic trigger frame 503 to STA1. After a short interframe space (SIFS), the STA1 may transmit a latency sensitive uplink (UL) physical layer protocol data unit (PPDU). After an SIFS, the AP may transmit a multi-block acknowledgement frame (multi-BA) 507 to STA1. In particular, STA1 sends latency-sensitive UL PPDU 505 and after sending the UL PPDU 305, it does not have any more latency-sensitive uplink packets to transmit. Moreover, the AP has no downlink latency-sensitive packet waiting for the STA1. Therefore, there is an unused portion of restricted TWT SP 509, illustrated as unused SP 511, if only latency-sensitive traffic is allowed during the restricted TWT SP 509.

In some embodiments, channel under-utilization due to under-utilized restricted TWT SP can be reduced by allowing latency-tolerant traffic in addition to latency-sensitive traffic for transmission during R-TWT SP. In particular, once the scheduled STA is done transmitting latency-sensitive traffic during an R-TWT SP, and if there is still time remaining in the SP, the scheduled STA can choose to transmit its latency-tolerant packets (if any) during the remainder of the SP. This may improve the channel utilization for the STA. However, this may present a fairness issue. In particular, regarding contention among the scheduled STAs, if one scheduled STA starts transmitting latency-tolerant traffic during the restricted TWT SP, it may not be fair for other scheduled STAs that are still transmitting latency-sensitive traffic during the SP. Furthermore, an STA with negative intentions may abuse this functionality by setting up TWT parameters such that there is always additional time left in the restricted TWT SP after transmitting latency-sensitive packets. Accordingly, restricted TWT operation may present a trade-off between channel utilization and fairness.

In some embodiments, a R-TWT scheduled STA, before transmitting during the R-TW SP any quality of service (QOS) data frame of a traffic identifier (TID) that is not within the R-TWT UL TID(s), can send a buffer status report (BSR) to the R-TWT scheduling AP for the TIDs corresponding to the R-TWT UL TID(s). In some embodiments, the R-TWT scheduling AP may use the buffer status report in prioritizing among the members of the R-TWT schedule.

In some embodiments, an R-TWT scheduled STA, before transmitting during the R-TW SP any QoS Data frame of a TID that is not within the R-TWT UL TID(s), can send an indication or frame to the R-TWT scheduling AP for the TIDs corresponding to the R-TWT UL TID(s). Such an indication or frame may indicate that the R-TWT scheduled STA is done with transmitting low latency traffic as identified by the R-TWT UL TID(s). In some embodiments, such indication or frame may indicate that the R-TWT scheduled STA intends to transmit latency tolerant traffic to the R-TWT Scheduling AP, where the latency tolerant traffic corresponds to TIDs not included in the R-TWT UL TID(s). In some embodiments, the indication may be for permission.

In some embodiments, a first STA may become a member of an R-TWT schedule, where the schedule is negotiated for a first set of R-TWT UL TID. The first STA may intend to transmit a frame to the R-TWT scheduling AP during the R-TWT SP corresponding to that R-TWT schedule. The frame may not correspond to a TID included in the first set of R-TWT UL TID negotiated for that schedule. Accordingly, the first STA can send a buffer status report (BSR) to the AP before transmitting a frame that does not correspond to a TID included in the first set of R-TWT UL TID negotiated for that schedule.

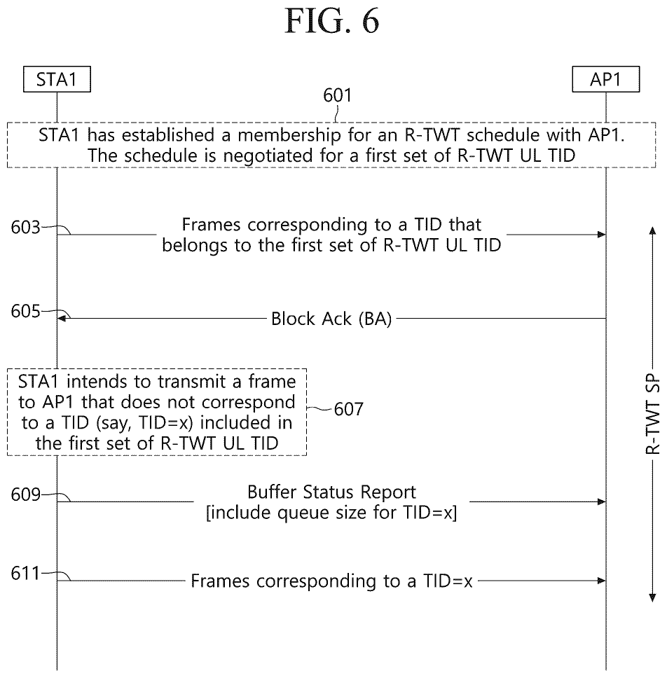

FIG. 6 illustrates transmitting a buffer status report (BSR) during R-TWT SP in accordance with an embodiment. Although one or more operations are described or shown in particular sequential order, in other embodiments the operations may be rearranged in a different order, which may include performance of multiple operations in at least partially overlapping time periods. As illustrated, STA1 is communicating with AP1. In operation 601, STA1 has established a membership for an R-TWT schedule with AP1. The schedule may be negotiated for a first set of R-TWT UL TID.

In operation 603, during the R-TWT SP, STA1 transmits to AP1 frames corresponding to a TID that belongs to the first set of R-TWT UL TID.

In operation 605, AP1 transmits to STA1 a block Ack (BA) in response to the frames from STA1.

In operation 607, STA1 intends to transmit a frame to AP1 that does not correspond to a TID (e.g., TID=x) included in the first set of R-TWT UL TID.

In operation 609, STA1 transmits to AP1 a buffer status report (BSR) that includes a queue size for TID=x. In some embodiments, the STA may transmit a BSR for the TIDs. In some embodiments, the request may indicate that the STA intends to transmit latency tolerant traffic to the AP, where the latency tolerant traffic corresponds to TIDs not included in the first set of R-TWT UL TID. In some embodiments, the STA may transmit a frame to the AP indicating a request to allow transmission of frames corresponding to one or more TIDs that do not correspond to a TID included in the first set of R-TWT UL TID. In some embodiments, the frame may include a list of TID that the STA intends to transmit during the R-TWT SP.

In some embodiments, the AP may transmit to STA1 a frame (e.g., an Ack or Block Acknowledgement frame) that may indicate that the AP permits or allows the transmission of the frame that does not correspond to a TID included in the first set of R-TWT UL TID. In some embodiments, if the AP allows such a frame transmission, then the AP can indicate in a response frame “Accept”, and if the AP does not allow such a frame transmission, then the AP may indicate in the response frame “Reject”.

In operation 611, STA1 transmits to AP1, frames corresponding to a TID=x.

In some embodiments, a first STA may become a member of an R-TWT schedule, where the schedule is negotiated for a first set of R-TWT UL TID. The first STA may intend to transmit a frame to the R-TWT scheduling AP during the R-TWT SP corresponding to that R-TWT schedule. The frame may not correspond to a TID included in the first set of R-TWT UL TID negotiated for that schedule. If the first STA sends during the R-TWT SP a BSR to the AP before transmitting a frame that does not correspond to a TID included in the first set of R-TWT UL TID negotiated for that schedule, then upon receiving the BSR, the AP can send an Ack or BA frame to the first STA. Transmitting this frame may indicate that the AP permits or allows the transmission of the frame that does not correspond to a TID included in the first set of R-TWT UL TID negotiated for that schedule.

In some embodiments, upon receiving the ACK or BA frame from the AP, the non-AP STA can transmit a frame that does not correspond to a TID included in the first set of R-TWT UL TID negotiated for that schedule during the R-TW SP corresponding to the R-TWT schedule.

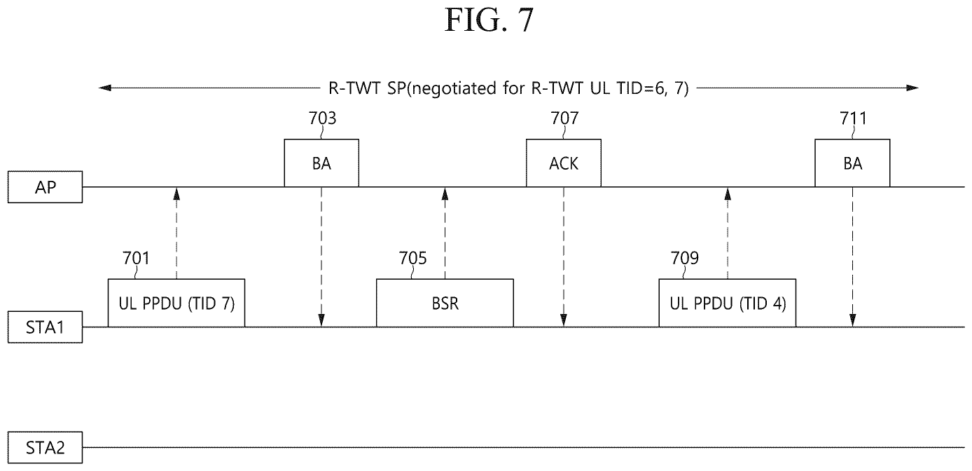

FIG. 7 illustrates a response to BSR transmission during R-TWT SP in a non-trigger-based R-TWT SP in accordance with an embodiment. In particular, FIG. 7 illustrates an AP, STA1 and STA2. AP is communicating with STA1. During an R-TWT SP, which has been negotiated for R-TWT UL TID-6 and 7, STA1 transmits a UL PPDU (with TID 7) 701 to AP. AP transmits a BA 703 to STA1. STA1 may intend to transmit a frame (e.g., UL PPDU with TID 4) 709 to the R-TWT scheduling AP during the R-TWT SP corresponding to that R-TWT schedule. The frame 709, which has a TID of 4, may not correspond to a TID included in the first set of R-TWT UL TID (e.g., TID of 6 or 7) negotiated for that schedule. Accordingly, STA1 sends during the R-TWT SP a BSR 705 to the AP before transmitting the UL PPDU frame 709 that does not correspond to a TID included in the first set of R-TWT UL TID negotiated for that schedule. In some embodiments, the BSR 705 may indicate pending traffic corresponding to the TID (e.g., TID of 4) that is not included in the first set of R-TWT UL TID (e.g., TID of 6 or 7). Upon receiving the BSR 705, the AP can send an Ack frame 707 to STA1. Transmitting the ACK frame 707 may indicate that the AP permits or allows the transmission of the frame that does not correspond to a TID included in the first set of R-TWT UL TID negotiated for that schedule. As illustrated, STA1 transmits a UL PPDU (with TID 4) 709 to AP. AP transmits a BA 711 to STA1.

In some embodiments, a first STA may become a member of an R-TWT schedule, where the schedule is negotiated for a first set of R-TWT UL TID. The first STA may intend to transmit a frame to the R-TWT scheduling AP during the R-TWT SP corresponding to that R-TWT schedule. The frame may not correspond to a TID included in the first set of R-TWT UL TID negotiated for that schedule. Accordingly, the first STA may send a frame to the AP indicating a request to allow transmission of frames corresponding to one or more TIDs that don't correspond to a TID included in the first set of R-TWT UL TID. This frame may include a list of TID that the first STA intends to transmit during the R-TWT SP. In some embodiments, one or more TIDs included in the list may not be included in the R-TWT UL TID set negotiated for the R-TWT schedule. The frame may be referred to as a Non-R-TWT TID Allowance Request frame. A format of a Non-R-TWT TID Allowance Request frame is shown in Table 1 in accordance with an embodiment.

TABLE 1

| Order | Information |
|---|---|
| 1 | Category |
| 2 | Unprotected S1G Action |
| 3 | Dialog Token |
| 4 | TID List |

As illustrated, the Non-R-TWT TID Allowance Request frame may include a category field, an unprotected S1G action field, a dialog token field, and a TID list field. The category field may provide a category of the frame. The unprotected SIG action field may include action information for the frame. The dialog token field may provide an identifier for identifying a frame exchange. The TID list may provide a list of TIDs for which the STA is requesting permission to transmit.

In some embodiments, a first STA may become a member of an R-TWT schedule, where the schedule is negotiated for a first set of R-TWT UL TID. The first STA may intend to transmit a frame to the R-TWT scheduling AP during the R-TWT SP corresponding to that R-TWT schedule. The frame may not correspond to a TID included in the first set of R-TWT UL TID negotiated for that schedule. Accordingly, if the first STA sends a frame to the AP indicating a request to allow transmission of frames corresponding to one or more TIDs that don't correspond to a TID included in the first set of R-TWT UL TID, then upon receiving the request frame, the AP can send a response to the first STA. The response frame may indicate whether the AP allows such frame transmission or not. In some embodiments, if the AP allows such a frame transmission, then the AP can indicate in the response frame ACCEPT; if the AP does not allow such a frame transmission, then the AP may indicate REJECT. In some embodiments, the AP may also include a TID list in the response frame, where the TID list may indicate a list of TIDs for which the corresponding frames are allowed for transmission during the R-TWT SP. The response frame may be referred to as a Non-R-TWT TID Allowance Response frame. A format of a Non-R-TWT TID Allowance Response frame is shown in Table 2 in accordance with an embodiment.

TABLE 2

| Order | Information |
|---|---|
| 1 | Category |
| 2 | Unprotected S1G Action |
| 3 | Dialog Token |
| 4 | TID List |
| 5 | Status Code |

The Non-R-TWT TID Allowance Response frame may include a category field, an unprotected S1G action field, a dialog token field, a TID list field, and a status code field. The category field may provide a category of the frame. The unprotected S1G action field may include action information for the frame. The dialog token field may provide an identifier for identifying a frame exchange. The TID list field may indicate a list of TIDs for which the corresponding frames are allowed for transmission during the R-TWT SP. The status code field may indicate whether the AP allows such frame transmission or not for TIDs not included in a negotiated set of TIDs. In some embodiments, if the AP allows such a frame transmission, then the AP can set the status code field to “ACCEPT”; if the AP does not allow such a frame transmission, then the AP can set the status code field to “REJECT”.

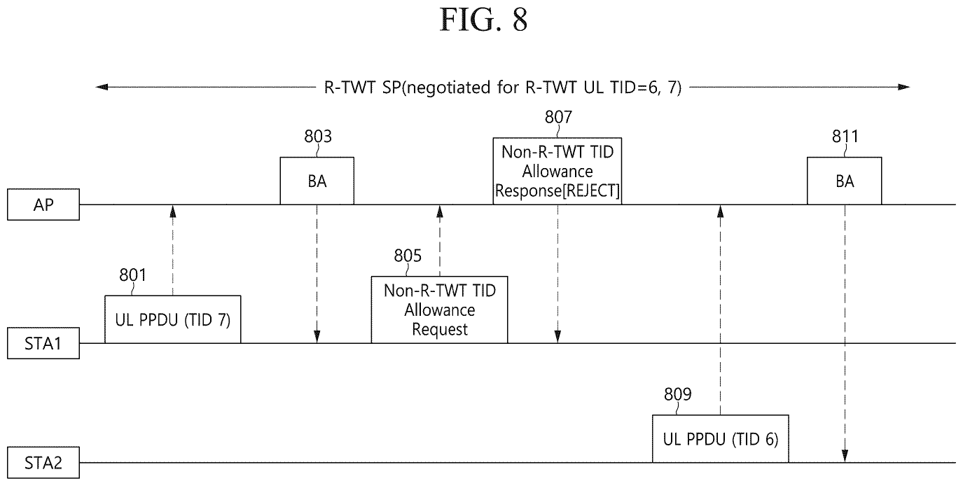

FIG. 8 illustrates a request rejection in accordance with an embodiment. In particular, FIG. 8 illustrates communication between AP, STA1 and STA2. An R-TWT SP may be negotiated for R-TWT UL TIDs 6 and 7. During the R-TWT SP, STA1 may transmit UL PPDU (TID 7) 801 to AP. AP may transmit BA 803 to STA1. STA1 may transmit a non-R-TWT TID Allowance Request frame 805 to AP. In particular, STA1 sends a non-R-TWT TID Allowance Request frame 805 to the AP indicating a request to allow transmission of frames corresponding to one or more TIDs that don't correspond to a TID included in the negotiated set of R-TWT UL TID (e.g., TID 6 or 7). Upon receiving the non-R-TWT TID Allowance Request frame 805, the AP can send a non-R-TWT TID Allowance Response frame 807 to STA1. The non-R-TWT TID Allowance Response frame 807 may indicate “Reject” meaning that the AP does not allow such a frame transmission. As illustrated, AP transmits a non-R-TWT-TID Allowance Response frame 807 with status code “Reject” to STA1. STA2 transmits UL PPDU (TID 6) to AP. AP may transmit BA 811 to STA2.

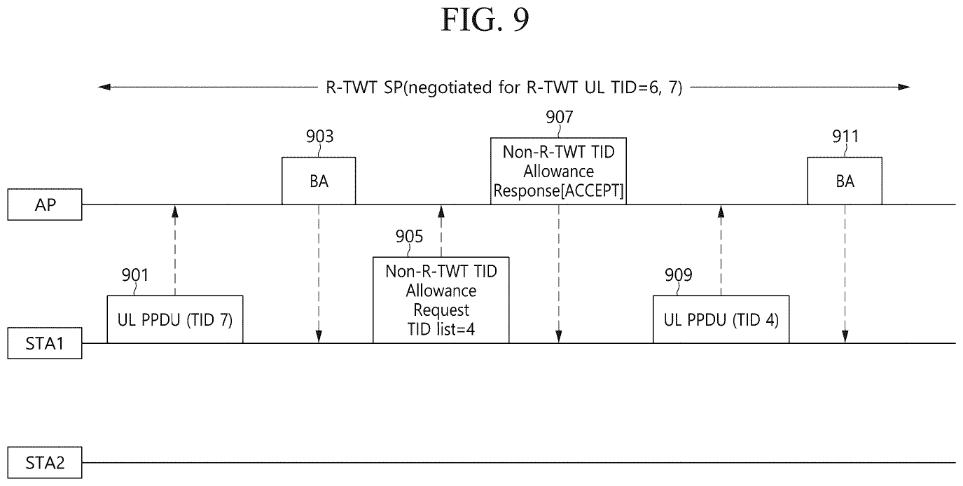

FIG. 9 illustrates a request acceptance in accordance with an embodiment. In particular, FIG. 9 illustrates communication between AP, STA1 and STA2. An R-TWT SP may be negotiated for R-TWT UL TIDs 6 and 7. During the R-TWT SP, STA1 may transmit UL PPDU (TID 7) 901 to AP. AP may transmit BA 903 to STA1. STA1 may transmit a non-R-TWT TID Allowance Request frame (with TID=4) 905 to AP. In particular, STA1 sends a non-R-TWT TID Allowance Request frame 905 to the AP indicating a request to allow transmission of frames corresponding to one or more TIDs (e.g., TID=4) that don't correspond to a TID included in the negotiated set of R-TWT UL TID (e.g., TID 6 or 7). Upon receiving the non-R-TWT TID Allowance Request frame 905, the AP can send a non-R-TWT TID Allowance Response frame 907 to STA1. The non-R-TWT TID Allowance Response frame 907 may indicates “Accept” meaning that the AP does allow such a frame transmission. As illustrated, AP transmits a non-R-TWT-TID Allowance Response frame 907 with status code “Accept” to STA1. Accordingly, STA1 transmits UL PPDU (TID 4) 909 to AP. AP may transmit BA 911 to STA1.

In some embodiments, a first STA may become a member of a trigger enabled R-TWT schedule. The schedule may be negotiated for a first set of R-TWT UL TID. The first STA may intend to transmit a frame to the R-TWT scheduling AP during the R-TWT SP corresponding to that R-TWT schedule. The frame may not correspond to a TID included in the first set of R-TWT UL TID negotiated for that schedule. If the first STA sends a BSR or any other frame to the AP indicating a pending buffer corresponding to a TID (e.g., TID=x) that is not included in the first set of R-TWT UL TID, then the AP can trigger the STA in order to facilitate its uplink transmission corresponding to TID=x.

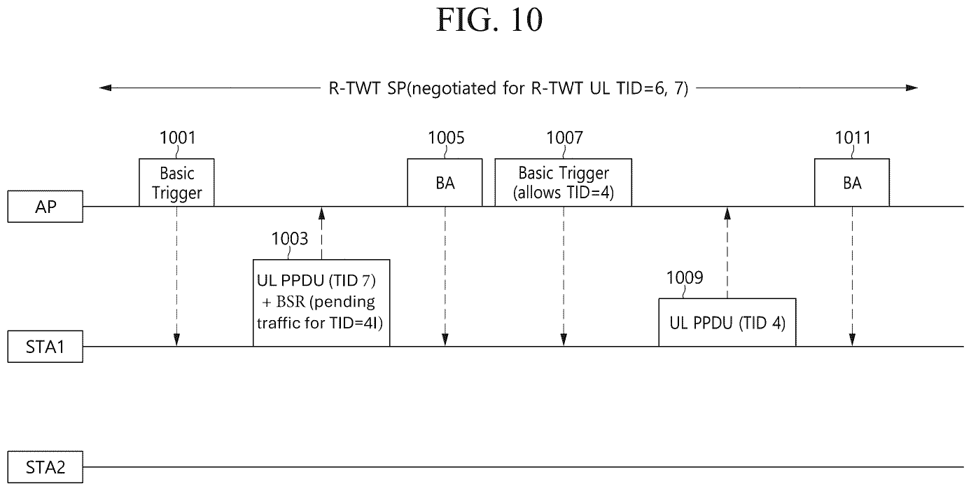

FIG. 10 illustrates triggering non-R-TWT TID frame transmission in accordance with an embodiment. In particular, FIG. 10 illustrates communication between AP, STA1 and STA2. An R-TWT SP may be negotiated for R-TWT UL TIDs 6 and 7. During the R-TWT SP, AP transmits a basic trigger frame 1001 to STA1. STA1 transmits a UL PPDU (with TID=7) and BSR (pending traffic for TID=4) 1003 to AP. In particular, STA1 sends a BSR to the AP indicating a pending buffer corresponding to a TID (e.g., TID=4), that is not included in the set of R-TWT UL TIDs (e.g., 6 or 7). AP transmits a BA 1005 to STA1. AP transmits a basic trigger (allow TID=4) 1007 to STA1 that indicates the AP is allowing TID=4, meaning that the AP will allow such a frame transmission. Accordingly, STA1 transmits UL PPDU (TID 4) to AP. AP transmits a BA 1011 to STA1.

In some embodiments, a first STA may become a member of a trigger-enabled R-TWT schedule. The schedule may be negotiated for a first set of R-TWT UL TID. The first STA may intend to transmit a frame to the R-TWT scheduling AP during the R-TWT SP corresponding to that R-TWT schedule. The frame may not correspond to a TID included in the first set of R-TWT UL TID negotiated for that schedule. The first STA may send a BSR or any other frame to the AP indicating a pending buffer corresponding to a TID (e.g., TID=x) that is not included in the first set of R-TWT UL TID. If the STA does not have any pending buffer traffic corresponding to a TID included in the first set of R-TWT UL TID, then the AP may not trigger the first STA for the remainder of the R-TWT SP duration. The AP may trigger a second STA that is a member of the same R-TWT schedule. In some embodiments, the AP may trigger a third STA that may not be a member of the same R-TWT schedule.

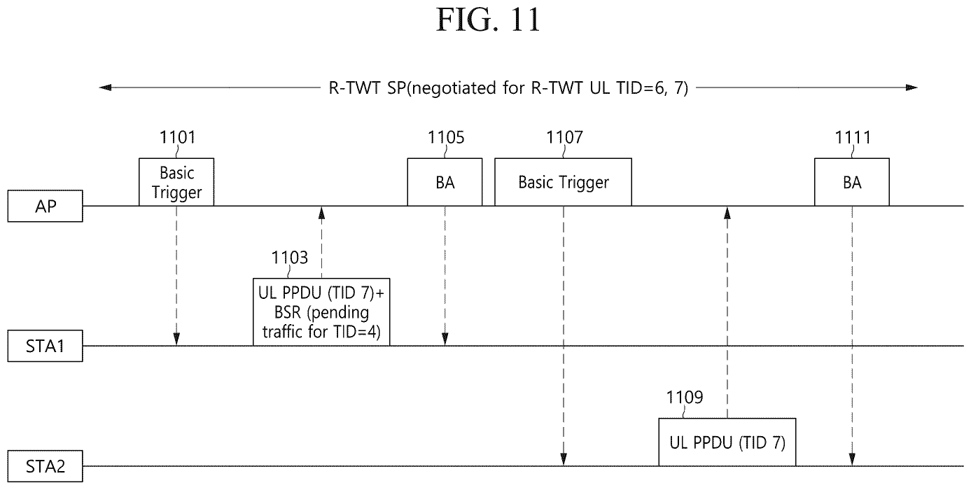

FIG. 11 illustrates triggering another STA during the R-TWT SP in accordance with an embodiment. In particular, FIG. 11 illustrates communication between AP, STA1 and STA2. An R-TWT SP may be negotiated for R-TWT UL TIDs 6 and 7. During the R-TWT SP, AP transmits a basic trigger frame 1101 to STA1. STA1 transmits a UL PPDU (with TID=7) and BSR (pending traffic for TID=4) 1103 to AP. In particular, STA1 sends a BSR to the AP indicating a pending buffer corresponding to a TID (e.g., TID=4), that is not included in the set of R-TWT UL TIDS (e.g., 6 or 7). AP transmits a BA 1105 to STA1. In particular, if the STA does not have any pending buffer traffic corresponding to a TID included in the negotiated set of R-TWT UL TIDS (e.g., 6 or 7), then the AP may not trigger the STA1 for the remainder of the R-TWT SP duration. The AP may trigger a second STA, STA2, that is a member of the same R-TWT schedule. Accordingly, AP transmits a basic trigger frame 1107 to STA2. STA2 transmits UL PPDU (TID 7) 1109 to AP. AP transmits a BA 1111 to STA2.

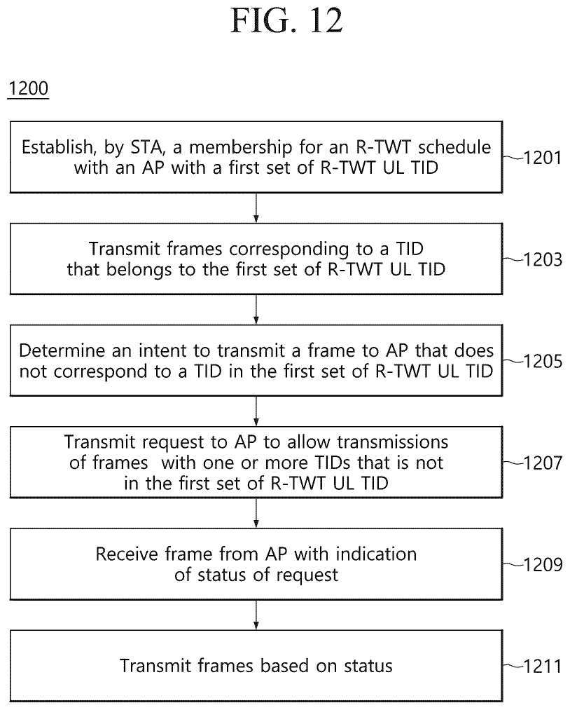

FIG. 12 illustrates a flow chart of an example process by an STA requesting permission to transmit for a new TID in accordance with an embodiment. Although one or more operations are described or shown in particular sequential order, in other embodiments the operations may be rearranged in a different order, which may include performance of multiple operations in at least partially overlapping time periods. The flowchart depicted in FIG. 12 illustrates operations performed in a non-AP STA, such as STA illustrated in FIG. 3.

The process 1200 begins in operation 1201.

In operation 1201, the STA establishes a membership for an R-TWT schedule with an AP with a first set of R-TWT UL TID.

In operation 1203, the STA transmits frames corresponding to a TID that belongs to the first set of R-TWT UL TID.

In operation 1205, the STA determines an intent to transmit a frame to the AP that does not correspond to a TID in the first set of R-TWT UL TID.

In operation 1207, the STA transmits a request to the AP to allow transmissions of frames with one or more TIDs that is not in the first set of R-TWT UL TID. In some embodiments, the STA may transmit a BSR for the TIDs. In some embodiments, the request may indicate that the STA intends to transmit latency tolerant traffic to the AP, where the latency tolerant traffic corresponds to TIDs not included in the first set of R-TWT UL TID. In some embodiments, the STA may transmit a frame to the AP indicating a request to allow transmission of frames corresponding to one or more TIDs that do not correspond to a TID included in the first set of R-TWT UL TID. In some embodiments, the frame may include a list of TID that the STA intends to transmit during the R-TWT SP.

In operation 1209, the STA receives a frame from the AP with an indication of status of the request. In some embodiments, the frame may be an Ack or BA frame. The frame may indicate that the AP permits or allows the transmission of the frame that does not correspond to a TID included in the first set of R-TWT UL TID. In some embodiments, if the AP allows such a frame transmission, then the AP can indicate in a response frame “Accept”, and if the AP does not allow such a frame transmission, then the AP may indicate in the response frame “Reject”.

In operation 1211, the STA transmits frames based on the status. In particular, if the AP permits the transmission, then the STA can transmit a frame that does not correspond to a TID included in the first set of R-TWT UL TID during the R-TWT SP. If the AP does not permit the transmission, then the STA may continue to transmit frames with TIDs in the first set of R-TWT UL TID. In some embodiments, a different STA may transmit frames to the AP, where the frames have a TID that is in the first set of R-TWT UL TID.

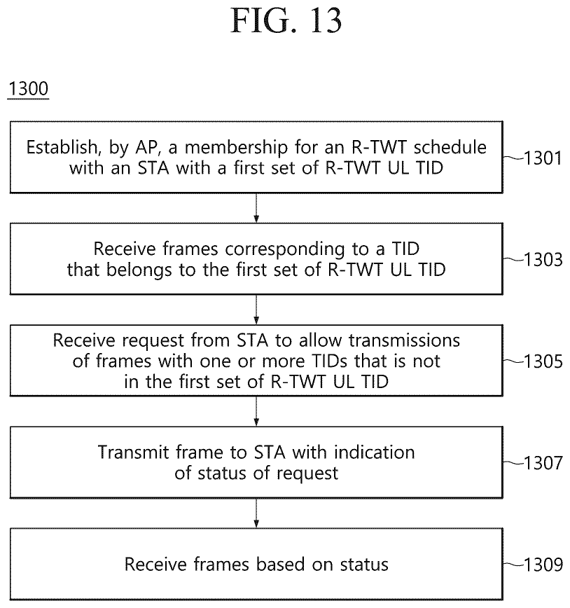

FIG. 13 illustrates a flow chart of an example process by an AP receiving a request from an STA to transmit to a new TID in accordance with an embodiment. Although one or more operations are described or shown in particular sequential order, in other embodiments the operations may be rearranged in a different order, which may include performance of multiple operations in at least partially overlapping time periods. The flowchart depicted in FIG. 13 illustrates operations performed in a AP MLD, such as AP MLD illustrated in FIG. 3.

The process 1300 begins in operation 1301.

In operation 1301, the AP establishes a membership for an R-TWT schedule with an STA with a first set of R-TWT UL TID.

In operation 1303, the AP receives frames from the STA corresponding to a TID that belongs to the first set of R-TWT UL TID.

In operation 1305, the AP receives a request from the STA to allow transmissions of frames with one or more TIDs that is not in the first set of R-TWT UL TID. In some embodiments, the AP may receive a BSR for the TIDs. In some embodiments, the request may indicate that the STA intends to transmit latency tolerant traffic to the AP, where the latency tolerant traffic corresponds to TIDs not included in the first set of R-TWT UL TID. In some embodiments, the AP may receive a frame from the STA indicating a request to allow transmission of frames corresponding to one or more TIDs that do not correspond to a TID included in the first set of R-TWT UL TID. In some embodiments, the frame may include a list of TID that the STA intends to transmit during the R-TWT SP.

In operation 1307, the AP transmits a frame to the STA with an indication of status of the request. In some embodiments, the frame may be an Ack or BA frame. The frame may indicate that the AP permits or allows the transmission of the frame that does not correspond to a TID included in the first set of R-TWT UL TID. In some embodiments, if the AP allows such a frame transmission, then the AP can indicate in a response frame “Accept”, and if the AP does not allow such a frame transmission, then the AP may indicate in the response frame “Reject”.

In operation 1309, the AP receives frames based on the status. In particular, if the AP permits the transmission, then the AP can receive a frame from the STA that does not correspond to a TID included in the first set of R-TWT UL TID during the R-TWT SP. If the AP does not permit the transmission, then the AP may continue to receive frames with TIDs in the first set of R-TWT UL TID. In some embodiments, the AP may receive frames from a different STA, where the frames have a TID that is in the first set of R-TWT UL TID.

Embodiments in accordance with this disclosure may minimize channel under-utilization due to under-utilized restricted TWT SP by allowing latency-tolerant traffic in addition to latency-sensitive traffic for transmission during R-TWT SP. In particular, once a scheduled STA is done transmitting latency-sensitive traffic during an R-TWT SP, and if there is still time remaining in the SP, the scheduled STA can choose to transmit its latency-tolerant packets (if any) during the remainder of the SP which may improve the channel utilization for the STA and thus improve traffic performance on the wireless network.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

As described herein, any electronic device and/or portion thereof according to any example embodiment may include, be included in, and/or be implemented by one or more processors and/or a combination of processors. A processor is circuitry performing processing.

Processors can include processing circuitry, the processing circuitry may more particularly include, but is not limited to, a Central Processing Unit (CPU), an MPU, a System on Chip (SoC), an Integrated Circuit (IC) an Arithmetic Logic Unit (ALU), a Graphics Processing Unit (GPU), an Application Processor (AP), a Digital Signal Processor (DSP), a microcomputer, a Field Programmable Gate Array (FPGA) and programmable logic unit, a microprocessor, an Application Specific Integrated Circuit (ASIC), a neural Network Processing Unit (NPU), an Electronic Control Unit (ECU), an Image Signal Processor (ISP), and the like. In some example embodiments, the processing circuitry may include: a non-transitory computer readable storage device (e.g., memory) storing a program of instructions, such as a DRAM device; and a processor (e.g., a CPU) configured to execute a program of instructions to implement functions and/or methods performed by all or some of any apparatus, system, module, unit, controller, circuit, architecture, and/or portions thereof according to any example embodiment and/or any portion of any example embodiment. Instructions can be stored in a memory and/or divided among multiple memories.

Different processors can perform different functions and/or portions of functions. For example, a processor 1 can perform functions A and B and a processor 2 can perform a function C, or a processor 1 can perform part of a function A while a processor 2 can perform a remainder of function A, and perform functions B and C. Different processors can be dynamically configured to perform different processes. For example, at a first time, a processor 1 can perform a function A and at a second time, a processor 2 can perform the function A. Processors can be located on different processing circuitry (e.g., client-side processors and server-side processors, device-side processors and cloud-computing processors, among others).

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A station (STA) in a wireless network, the STA comprising:
a memory; and
a processor coupled to the memory, the processor configured to:
establish a membership for a restricted target wake time (R-TWT) schedule with an access point (AP) for a set of traffic identifiers (TIDs);
transmit, to the AP, one or more frames corresponding to one or more TIDs that belong to the set of TIDs within a service period (SP);
transmit, to the AP, an indication indicating pending traffic with a TID that does not belong to the set of TIDs;
receive, from the AP, an indication indicating acceptance of transmission of the pending traffic; and
transmit, to the AP, one or more frames corresponding to the TID that does not belong to the set of TIDs.

2. The STA of claim 1, wherein the indication indicating the pending traffic with the TID that does not belong to the set of TIDs is included within a buffer status report.

3. The STA of claim 1, wherein the indication indicating the pending traffic with the TID that does not belong to the set of TIDs is included within a request frame that includes a request to allow transmission of the pending traffic.

4. The STA of claim 1, wherein the indication indicating the acceptance is received from the AP within a response frame that allows transmission of the pending traffic.

5. The STA of claim 1, wherein the set of TIDs is associated with latency sensitive traffic.

6. The STA of claim 1, wherein the TID that does not belong to the set of TIDs is associated with latency tolerant traffic.

7. The STA of claim 1, wherein:
the processor is further configured to receive, from the AP, a trigger frame that solicits transmission of the pending traffic; and
the one or more frames corresponding to the TID that does not belong to the set of TIDs is transmitted in response to the trigger frame.

8. An access point (AP) in a wireless network, the AP comprising:
a memory; and
a processor coupled to the memory, the processor configured to:
establish a membership for a restricted target wake time (R-TWT) schedule with a station (STA) for a set of traffic identifiers (TIDs);
receive, from the STA, one or more frames corresponding to one or more TIDs that belongs to the set of TIDs within a service period (SP);
receive, from the STA, an indication indicating pending traffic with a TID that does not belong to the set of TIDS;
transmit, to the STA, an indication indicating acceptance of transmission of the pending traffic; and
receive, from the STA, one or more frames corresponding to the TID that does not belong to the set of TIDs.

9. The AP of claim 8, wherein the indication indicating the pending traffic with the TID that does not belong to the set of TIDs is included within a buffer status report.

10. The AP of claim 8, wherein the indication indicating the pending traffic with the TID that does not belong to the set of TIDs is included within a request frame that includes a request to allow transmission of the pending traffic.

11. The AP of claim 8, wherein the indication indicating the acceptance is transmitted to the STA within a response frame that allows transmission of the pending traffic.

12. The AP of claim 8, wherein the set of TIDs is associated with latency sensitive traffic.

13. The AP of claim 8, wherein the TID that does not belong to the set of TIDs is associated with latency tolerant traffic.

14. The AP of claim 8, wherein:
the processor is further configured to transmit, to the STA, a trigger frame that solicits transmission of the pending traffic; and
the one or more frames corresponding to the TID that does not belong to the set of TIDs is received in response to the trigger frame.

15. A computer-implemented method for communication by a station (STA) in a wireless network, comprising:
establishing a membership for a restricted target wake time (R-TWT) schedule with an access point (AP) for a set of traffic identifiers (TIDs);
transmitting, to the AP, one or more frames corresponding to one or more TIDs that belongs to the set of TIDs within a service period (SP);
transmitting, to the AP, an indication indicating pending traffic with a TID that does not belong to the set of TIDS;
receiving, from the AP, an indication indicating acceptance of transmission of the pending traffic; and
transmitting, to the AP, one or more frames corresponding to the TID that does not belong to the set of TIDs.

16. The computer-implemented method of claim 15, wherein the indication indicating the pending traffic with the TID that does not belong to the set of TIDs is included within a buffer status report.

17. The computer-implemented method of claim 15, wherein the indication indicating the pending traffic with the TID that does not belong to the set of TIDs is included within a request frame that includes a request to allow transmission of the pending traffic.

18. The computer-implemented method of claim 15, wherein the indication indicating the acceptance is received from the AP within a response frame that allows transmission of the pending traffic.

19. The computer-implemented method of claim 15, wherein the set of TIDs is associated with latency sensitive traffic.

20. The computer-implemented method of claim 15, wherein the TID that does not belong to the set of TIDs is associated with latency tolerant traffic.
